(19) United States
(12) Patent Application Publication
(10) Pub. No.: US 2006/0042619 A1
(43) Pub. Date: Mar. 2, 2006

(54) Broiler tool

(76) Inventor: James D. Comfort, Peoria Heights, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/933,111

(22) Filed: Sep. 2, 2004

(51) Int. Cl. A21B 1/08

(52) U.S. Cl. 126/20

(57) ABSTRACT

A broiler tool including at least one stand, such stand being adapted to seat on a broiler grill; a char station, the char station being supported by the at least one stand, and the char station being at a first level above the grill; and a shield, the shield being supported by the at least one stand, and the shield being at a second level above the grill and above the char station.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND

Although broiling meat is an old and well developed art, several problems in this art remain for the modern restaurateur offering fine dining. These include cooking several items, such as steaks, to order simultaneously in the same broiler. Cooks must manage multiple steaks in a broiler so that a particular steak may be prepared well done, without overcooking adjacent steaks that are ordered to be prepared medium or rare.

Modern broilers are generally comprised of a downward facing horizontal flat surface comprised of perforated tiles. Above the tiles are infra red heating elements that create a space beneath the tiles that is heated, typically in the range of 1400-1600 degrees. Below this space is arranged an upward facing horizontal grill. The grill is entirely flat, usually backed by a short vertical wall to prevent steaks from slipping over the back end. The sides of the grill typically have narrow channels running forward to back. The entire grill is mounted on a drawer that a cook may slide in and out horizontally. Commercial grade grills are generally large enough to accommodate simultaneous cooking of anywhere from one to fifty steaks. The drawers are generally controllable so that they can be moved to selected heights. A typical mechanical control device is a lever with alternative resting slots. The cook's selection of one or another of the slots places the grill at one or another vertical distance from the heating tiles above it. Accordingly, the preparation of the steaks may be controlled in only two ways: by the distance of the top surface of the steak from the heating tiles; and by controlling the amount of time the steak is cooked.

The problem of properly cooking a steak and improperly cooking adjacent steaks is complicated when a customer orders a steak to be prepared in a fashion known as “char” or “char rare.” This method of preparation requires very rapid cooking of at least one surface of a steak so that it becomes well done at the surface, while remaining rare, or even cool, in the middle. In order to properly repair a “char rare” steak, the steak must be placed very close to the heating elements. Within a typical modern broiler for a commercial restaurant as described, this distance would be on the order of an inch. The time required for properly charring a single side of a “char rare” steak is on the order of two minutes. Thus, within the generalized problem of properly cooking adjacent steaks to different preparation orders, there is the particular problem of cooking any steaks at all in a broiler simultaneously with a steak ordered “char rare,” without improperly also charring steaks that are not ordered “char rare.” Prior solutions to this dilemma have been simply to cook the “char rare” steak by itself. On a busy night when many orders need to be prepared, this solution delays the preparation of most steaks for many customers and leads to obvious work flow difficulties in the kitchen.

There is a need in the art for a broiling tool with which a steak may be prepared “char rare” or “well done” without interrupting the simultaneous preparation of other steaks ordered to be prepared differently. Moreover, the action of withdrawing and reinserting the grill door into the broiler, especially when the broiler is being put in heavy use by a busy cook, requires that any tool being used to supplement the grill would be capable of a reasonable fixation or interlocking with the standard grill and drawer components to prevent unwanted movement of the tool dulling use of the grill drawer. There is a need to minimize the number of tools or items in a broiler cooking space. Finally, there is an ongoing need for economy and durability.

### BRIEF DESCRIPTION OF THE DRAWINGS

FIG. 1 is a perspective view of the broiler tool of the present invention;

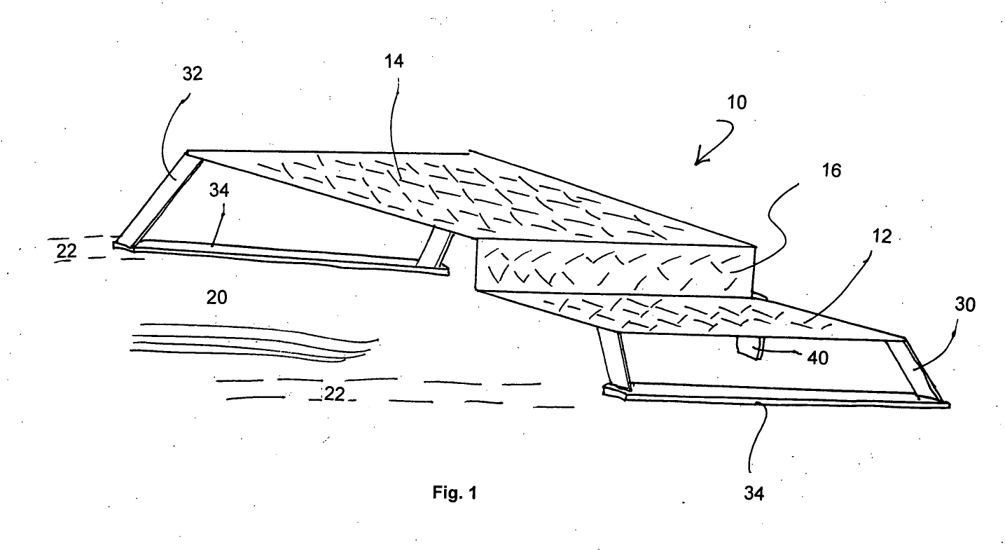

FIG. 2 is a side view of the broiler tool;

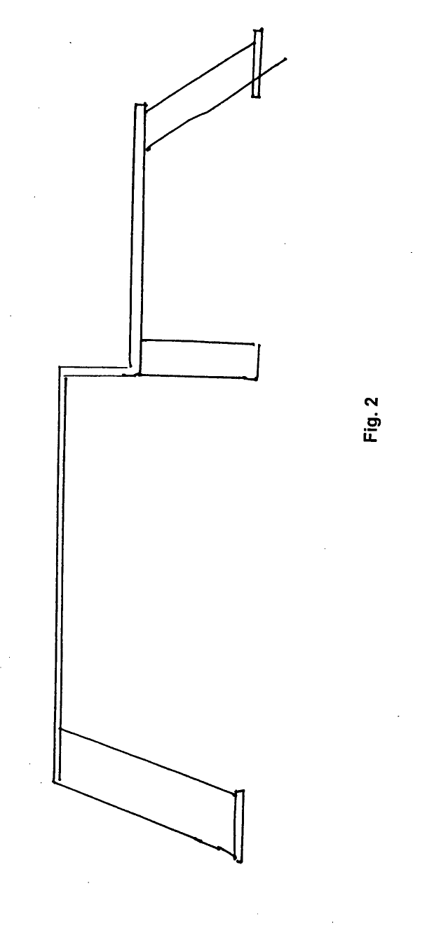

FIG. 3 is a top view of the broiler tool;

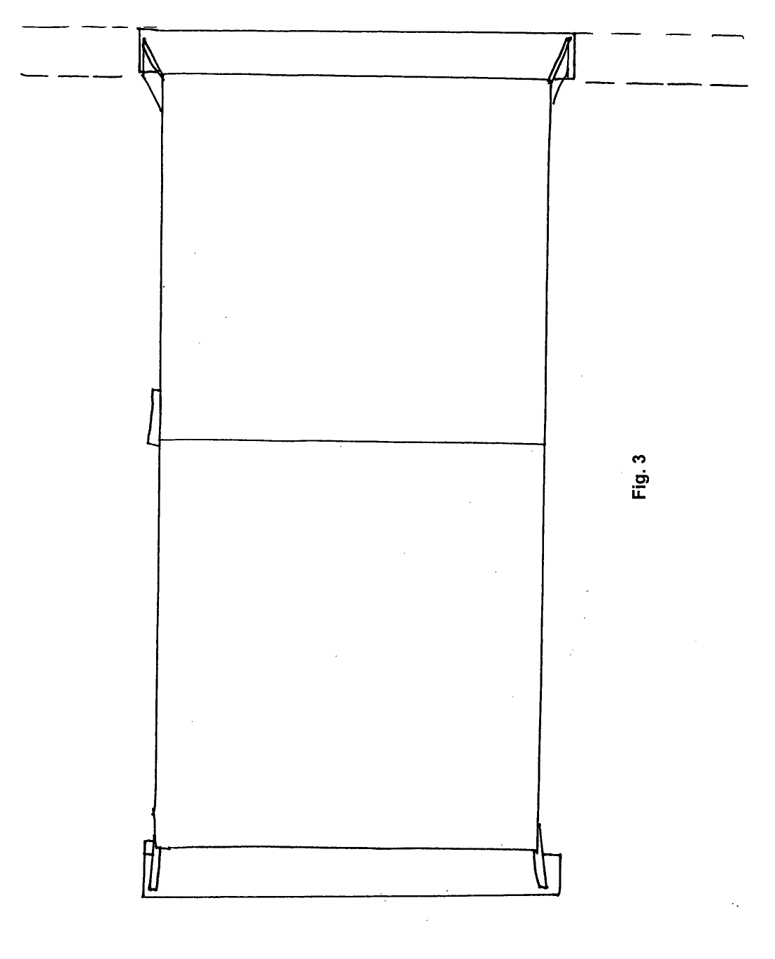

FIG. 4 is a top view of the broiler tool showing an embodiment of the shield.

### DETAILED DESCRIPTION

Referring to the accompanying drawings in which like reference numbers indicate like elements, broiler tool 10 is configured and dimensioned to be mounted in a broiler on the grill drawer and over the grill. The broiler tool 10 includes a char station 12 and a shield 14.

The grill is comprised of multiple parallel bars or rods 20 arranged in a horizontal bed. The depicted grill is flanked by channels 22, which are narrow, aligned along the direction the drawer travels, and somewhat lower than the grill bed 20. Steaks to be cooked are placed on the grill bed 20. Accordingly, the grill bed 20 is a first cooking surface beneath the horizontal heating element above.

The broiler tool 10 defines a second cooking surface, the char station 12. It is anywhere from 2-4 inches above the grilling surface. When added to a standard thickness of a steak, which is on the order of 2½-3½ inches, in the type of restaurants using the broilers herein described, the char station is dimensioned at a sufficient height to place the top surface of a steak to be prepared char rare within an inch of the heating surface above it.

The additional elevation of the char station 12 allows a single or small number of steaks to be prepared char rare, while a number of other steaks remain on the grill bed 20 for other preparations.

It may also be the case that certain steaks are ordered rare. Any steak may be shielded from the heat, according to the cook's discretion, but a heat shield would be particularly useful for preparation of rare steaks. Accordingly, the shield 14 is dimensioned to be at a third elevation. The shield 14 is to be positioned above a cooking steak and between it and the horizontal heating element above. In this fashion the broiler tool 10 gives the cook additional control. The shield 14 blocks the heat radiating from the heating element above onto the steak, thereby slowing its cooking.

Both the char station 12 and the shield 14, as well as a transitional member 16 between them, are constructed of a perforated metal grid, grill, grating or other material suitable for withstanding heat, supporting a steak and also having perforations therein.

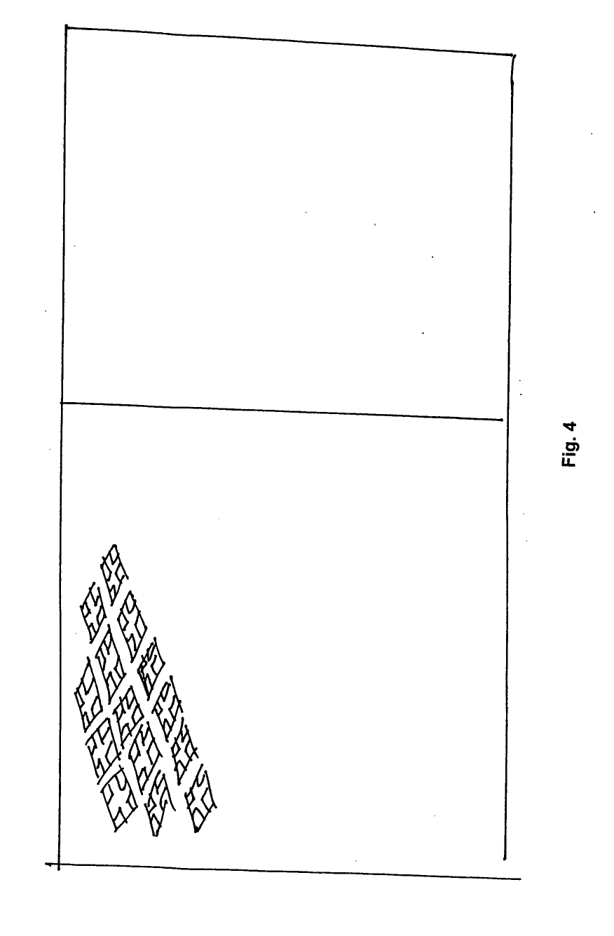

The shield 14 is further comprised of an additional modification. In the disclosed embodiment, as is best seen in FIG. 4, the shield 14 is comprised of two metal grates, each made from a heavy perforated mesh. In the depicted embodiment, these grates are overlapping and offset from one another. The effect of connecting two grates in a layered fashion, one on top of another horizontally, and offsetting them is to increase the amount of metal shielding surface, and decrease the surface area of the perforations there-through. The metal intersections of one grate are located over the holes of the other grate, creating four small holes where a single grate would have one large hole. The depicted embodiment has been found to usefully correspond to the structural configuration and heat characteristics of standard commercial broilers.

The broiler tool 10 is further comprised of legs 30 and 32. The legs attach the char station 12 and shield 14 to support bars 34. In the depicted embodiment, support bars 34 are dimensioned to fit within channels 22 of the grill drawer. Thus, the broiler tool 10 is stabilized against unwanted movement, while the legs 30 and 32 support the broiler tool 10 at the preconfigured elevations.

The depicted embodiment of the broiler tool also includes a hook or stop 40. This element is attached to the back of the broiler tool 10 and positioned to contact a back panel of the broiler drawer. Thus, the stop or hook 40 prevents unwanted forwards and backwards motion of the broiler tool 10 when the drawer is opened and shut.

In the depicted embodiment, the legs 30 and 32 are slanted diagonally. This configuration places the lateral edges of the char station 12 and shield 14 inboard of the channels 22. This configuration provides clearance for certain mechanical linkages found in some commercial grills, which may include travel bars, levers, and the like with bolts that project inwardly and would interfere with travel of the broiler tool were the offset legs not used.

The shield is dimensioned at a height sufficient for a standard thickness of steak to be placed underneath it.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A broiler tool comprising:
at least one stand, such stand being adapted to seat on a broiler grill;
a char station, said char station being supported by said at least one stand, and said chat station being at a first level above the grill; and
a shield, said shield being supported by said at least one stand, and said shield being at a second level above the grill and above said char station.

2. The broiler tool of claim 1, further comprising a hook, said hook being attached to the back of the broiler tool and said hook extending downwardly from said char station and said hook being dimensioned to engage a grill drawer component such that movement of the broiler tool relative to the grill drawer is prevented.

3. The broiler tool of claim 1 wherein said at least one stand is dimensioned to engage a side channel of the grill.

4. The broiler tool of claim 1 wherein said shield is in the range of 2-4 inches above the grill.

5. The broiler tool of claim 1 wherein said char station is in the range of 1-3 inches above the grill.

6. The broiler tool of claim 1 wherein said shield and said char station are comprised of a metal grid.

7. The broiler tool of claim 6 wherein said shield is comprised of two metal grids attached from each other in an offset fashion.

8. The broiler tool of claim 1 wherein said char station and said shield are perforated.

9. The broiler tool claim 8 wherein such perforations in said shield are smaller than said perforations in said char station.

10. The broiler tool of claim 1 wherein said at least one stand is slanted.
